(19) United States
(12) Patent Application Publication
(10) Pub. No.: US 2026/0065728 A1
(43) Pub. Date: Mar. 5, 2026

(54) SYSTEMS AND METHODS FOR SECURE RFID/NFC COMMUNICATIONS

(71) Applicant: CenturyLink Intellectual Property LLC, Denver, CO (US)

(72) Inventors: John R. B. Woodworth, Amissville, VA (US); Dean Ballew, Sterling, VA (US)

(73) Assignee: CenturyLink Intellectual Property LLC, Denver, CO (US)

(21) Appl. No.: 19/318,899

(22) Filed: Sep. 4, 2025

Related U.S. Application Data
(60) Provisional application No. 63/690,548, filed on Sep. 4, 2024.

(51) Int. Cl. G07C 9/00; H04W 12/102; H04W 12/47; H04W 12/65

(52) U.S. Cl. CPC G07C 9/00309; G07C 2009/00555; H04W 12/102; H04W 12/47; H04W 12/65

(57) ABSTRACT

Systems and methods for enabling secure RFID/NFC communications and thwarting relay attacks are described. A device that includes an RFID or NFC tag (such as a credit card with an NFC tag or a key fob with an RFID tag) includes a sensor system configured to detect, in response to the device receiving a request for information from a tag reader, one or more physical inputs. For example, the sensor system may include a photoresistor that detects light around the device, the presence of which indicates that the device is probably not in the user's wallet or pocket (and therefore probably is not experiencing a relay attack). When the device determines that the sensor output satisfies one or more criteria (such as when sensor system detects light around the device), the device transmits the information to the tag reader; otherwise the device does not transmit the information.

### CROSS-REFERENCES TO RELATED APPLICATIONS

This application claims the benefit of U.S. Provisional Application No. 63,690,548 filed Sep. 4, 2024, entitled “Systems and Methods for Secure RFID/NFC Communications,” which is incorporated herein by reference in its entirety.

### BACKGROUND

Some devices, such as credit cards and key fobs, use a radio-frequency identification (RFID) tag, such as a near-field communication (NFC) tag or another type of tag, that enables the device to provide authentication information and/or other information to an RFID/NFC tag reader upon a request from the RFID/NFC tag reader. As used herein, the notation “RFID/NFC” is intended to convey that the item can include an NFC chip or subsystem or another type of RFID chip or subsystem. The RFID/NFC tag reader may be, for example, a payment terminal or a tag reader in a vehicle. The RFID/NFC tag typically includes a microchip that stores and/or generates authentication information and/or other types of information. As an example of the use of RFID/NFC tags, a payment terminal may be configured to perform monetary transactions based on authentication information and/or other information received from an RFID/NFC tag embedded in the credit card. Such RFID-equipped devices enable wireless and contactless communications (such as monetary transactions) but may be vulnerable to relay attacks in which attackers relay and amplify the signals exchanged between the RFID/NFC tag and the tag reader to perform unauthorized transactions. It is with respect to this general technical environment that aspects of the present disclosure are directed.

### SUMMARY

The present application describes a method performed at a device having a radio frequency identification (RFID)/near-field communication (NFC) tag, the method including: receiving, from an RFID/NFC tag reader via an antenna of the device, a request for information; in response to receiving the request for information, obtaining one or more inputs including at least one representation of a physical input detected by a sensor system of the device; in accordance with the one or more inputs satisfying each of one or more criteria, transmitting, via the antenna, the information; and in accordance with the one or more inputs failing to satisfy at least one of the one or more criteria, refraining from transmitting the information.

In some examples, the RFID/NFC tag is a near-field communication (NFC) tag and the antenna includes an inductor, and receiving the request for information via the antenna includes generating, by the inductor of the antenna, a first electric current in response to exposure to a magnetic field.

In some examples, the first electric current has an RF frequency associated with NFC communications.

In some examples, the RFID/NFC tag is a passive NFC tag and, in accordance with one or more inputs satisfying the one or more criteria, the first electric current is supplied to the passive NFC tag to cause the NFC tag to be powered up.

In some examples, the information is transmitted in response to the NFC tag being powered up.

In some examples, the sensor system includes a photoresistor coupled between the antenna and the passive NFC tag and configured to establish an electrical connection between the antenna and the NFC tag when the sensor system detects light that satisfies light criteria.

In some examples, the method further includes determining, by processing circuitry of the device, whether the one or more inputs satisfies the one or more criteria.

In some examples, the sensor system includes a photodetector configured to detect light impinging on the device, the representation of the physical input includes a representation of the detected light, and the one or more inputs satisfies a first criterion of the one or more criteria when the representation of the detected light satisfies light criteria.

In some examples, the sensor system includes a pressure sensor system configured to detect a pressure on a surface of the device, the representation of the physical input includes a representation of the detected pressure, and the one or more inputs satisfies a second criterion of the one or more criteria when the representation of the detected pressure satisfies pressure criteria.

In some examples, the sensor system includes a touch sensor system configured to detect a physical touch on the device, the representation of the physical input includes a representation of the detected physical touch, and the one or more inputs satisfies a third criterion of the one or more criteria when the representation of the detected physical touch satisfies touch criteria.

In some examples, the one or more inputs includes an enablement switch setting, and the one or more criteria fail to be satisfied when the enablement switch setting is set to an enabled setting and the representation of the physical input fails to satisfy a first criterion of the one or more criteria.

In some examples, the one or more inputs includes an enablement switch setting, and each of the one or more criteria are satisfied when the enablement switch setting is a disabled setting.

In other aspects, the present application describes a device that includes: a passive near-field communication (NFC) tag that includes processing circuitry; an antenna including an inductor configured to generate an electric current in response to exposure to a magnetic field; and a sensor system configured to detect a physical input; where the device is configured to: generate, using the inductor, a first electric current based on exposure to a magnetic field generated by an NFC tag reader, where the first electric current includes a request for information from the NFC tag reader, in response to generating the first electric current, obtaining one or more inputs including at least one representation of a physical input detected by a sensor system of the device; in accordance with the one or more inputs satisfying each of the one or more criteria, providing a second electric current to the antenna to transmit the information; and in accordance with the one or more inputs failing to satisfy at least one of the one or more criteria, refraining from providing the second electric current to the antenna.

In some examples, the second electric current represents the information in a format that conforms to an NFC communication protocol.

In some examples, the first electric current is supplied to the passive NFC tag to cause the passive NFC tag to be powered up.

In some examples, the sensor system includes a photoresistor coupled between the inductor and the passive NFC tag and configured to establish an electrical connection between the inductor and the passive NFC tag when the sensor system detects light that satisfies light criteria.

In some examples, the second electric current is provided to the antenna in response to the passive NFC tag being powered up.

In some examples, the information includes data stored on the device.

In some examples, the passive NFC tag is coupled with the inductor and the sensor system and configured to receive the first electric current from the inductor and the sensor output from the sensor, and where the processing circuitry of the passive NFC tag is configured to determine whether the one or more inputs satisfies the one or more criteria.

In other aspects, the present application describes a device that includes: a radio-frequency identification (RFID) tag that includes processing circuitry; an RF antenna configured to generate an electrical current in response to receiving a signal in an RF frequency range; and
a sensor system configured to detect one or more physical inputs; where the device is configured to: in response to receiving the signal, detect, using a photoresistor of the device, an amount of light impinging on the device; in accordance with the amount of light exceeding a light threshold, obtain information from storage on the device and provide a second electric current representing the information to the antenna for transmission; and in accordance with the amount of light failing to exceed the light threshold, refrain from providing the second electric current to the antenna.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIGS. 1A-1B depict systems for communicating signals between an RFID/NFC tag and an RFID/NFC tag reader.

FIG. 2 depicts a system for secure RFID/NFC communication according to aspects of the present application.

FIGS. 3A-3C depict example devices for secure RFID/NFC communication according to aspects of the present application.

FIG. 4 depicts an example flowchart depicting a method for providing secure RFID/NFC-based communications according to aspects of the present application.

FIG. 5 is an example flow chart depicting a method for secure RFID/NFC communication according to aspects of the present application.

FIG. 6 is a block diagram of an example computing device that can be employed in relation to the present application.

### DETAILED DESCRIPTION

Some key fobs and credit cards use a radio frequency identification (RFID) tag, such as a near-field communication (NFC) tag or another type of tag, to provide authentication information to a tag reader (e.g., a reader in a vehicle or a payment terminal). The RFID/NFC tag typically includes a low-power microchip (e.g., a microcontroller, memory, and/or other circuitry) that stores and/or generates authentication information or other types of information. In operation, the tag reader transmits a signal that essentially requests information, such as authentication information, from the RFID/NFC tag. In response to receiving the signal from the tag reader, the RFID/NFC tag generates (or retrieves) the information and sends it to the tag reader.

NFC is a subset of RFID that is intended for communications over very short distances (e.g., 10 cm or less) and operates at a relatively low RF frequency (e.g., 13.56 MHZ). In addition, NFC has its own communication protocols (e.g., ISO 14443) that specify the format of communications exchanged between the tag and the reader. An NFC-equipped device, such as a credit card or smartphone, typically includes a passive (unpowered) NFC tag (e.g., a type of RFID tag) or an active (powered) NFC tag. Smartphones typically use active NFC tags that receive power from the phone battery. In contrast, a passive device, such as an NFC-equipped credit card or bus pass, may include a passive NFC tag embedded in the card.

Both the RFID/NFC tag reader and the RFID/NFC tag include an antenna for exchanging signals. For an RFID-based system, each of the antennas is an RF antenna configured to transmit/receive RF signals. For an NFC-based system, each of the antennas is (or includes) an inductor (e.g., a coil of conductive material). In this case, the NFC tag reader generates a magnetic field via the NFC antenna (e.g., by supplying current to the inductor that induces a magnetic field, which radiates away from the inductor). The magnetic field propagates energy (and potentially data) away from the tag reader. If the NFC antenna on a credit card is held close enough to (e.g., within 10 cm of) the NFC antenna of the tag reader and within its magnetic field, the magnetic field induces a current (and/or voltage) in the credit card's NFC antenna (which is also an inductor). The induced current/voltage is used to power up the NFC tag (for passive NFC tags) and/or to provide data to the NFC tag (for active NFC tags), which respond by transmitting information back to the reader via the NFC tag's NFC antenna.

Devices that include RFID or NFC tags, such as credit cards and key fobs, enable efficient wireless and contactless communications. They are, however, vulnerable to relay attacks in which one or more attackers (typically two) relay and amplify the signals exchanged between the tag and the tag reader to fraudulently authorize transactions or operations. As described herein, systems and methods for providing secure RFID/NFC communications can be used to thwart attempted relay attacks.

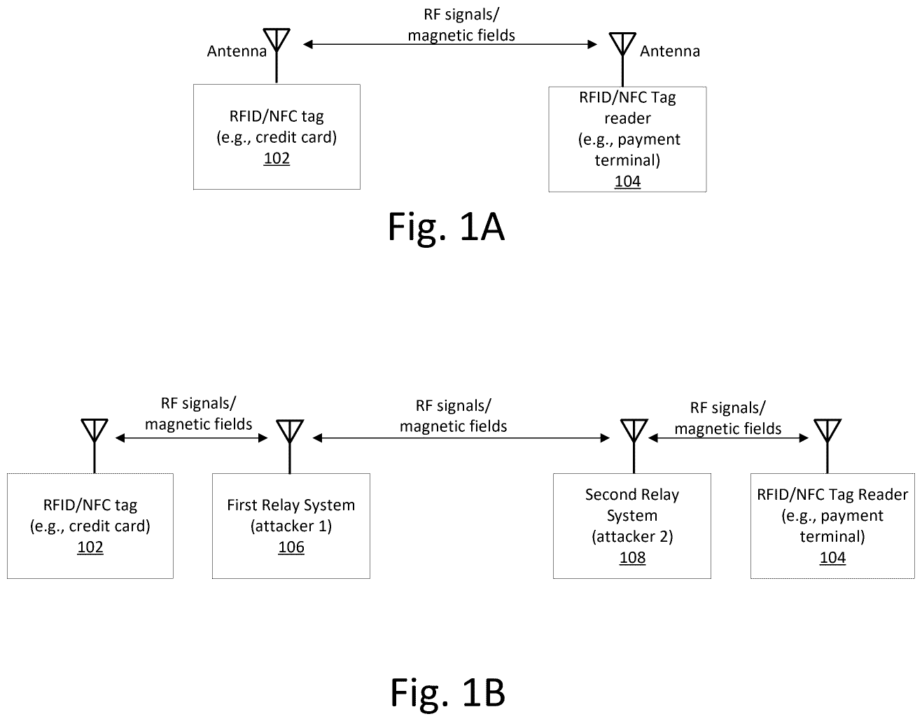

FIG. 1A depicts an example of an RFID/NFC-based system that includes a RFID/NFC tag 102 and an RFID/NFC tag reader 104. The RFID/NFC tag 102 may be an NFC tag or other type of RFID tag, and the RFID/NFC tag reader 104 may be an NFC tag reader or other type of RFID tag reader. The RFID/NFC tag reader 104 may be, for example, a payment terminal that is configured to exchange signals (such as radio waves or magnetic fields) with the RFID/NFC tag 102. RFID/NFC tag 102 may be embedded in a transaction card, such as a credit card. The tag reader 104 and tag 102 each includes an antenna, such as an RF antenna or NFC antenna, for exchanging signals, along with processing circuitry to process and/or generate such signals.

In some examples, the tag reader 104 transmits an RF signal (e.g., radiates an electromagnetic field) requesting authentication information either periodically or in response to receiving a request for a transaction (e.g., a request for payment).

As previously discussed, RFID/NFC-based systems may be vulnerable to malicious relay attacks, as depicted in FIG. 1B. In a relay attack, a first relay system 106 (e.g., an electronic system carried by a first attacker) may be positioned in close proximity to the RFID/NFC tag 102 and a second relay system 108 (e.g., an electronic system carried by a second attacker) may be positioned close to the tag reader 104. Signals transmitted by the RFID/NFC tag reader 104 may be captured, amplified, and relayed to the RFID/NFC tag 102 using the first relay system 106 and second relay system 108, and vice versa. The RFID/NFC tag receives the relayed signal and in response, transmits authentication information. If the RFID/NFC tag is an NFC tag, the NFC tag (e.g., including an NFC microchip) is powered up by the relayed signal and transmits its authentication information in response to being powered up. Thus, the tag reader 104 may receive, via the first and second relay systems, authentication information from the RFID/NFC tag 102 and authorize a payment-which may occur with a user of the RFID/NFC tag 102 being completely unaware that it is occurring.

As described herein, systems and methods for providing secure RFID/NFC communication include the use of a sensor in (or on) a device that includes a tag (e.g., in a credit card, key fob, or other device) to ensure that the device is not in the user's wallet or pocket (which could indicate an illegitimate use of the device).

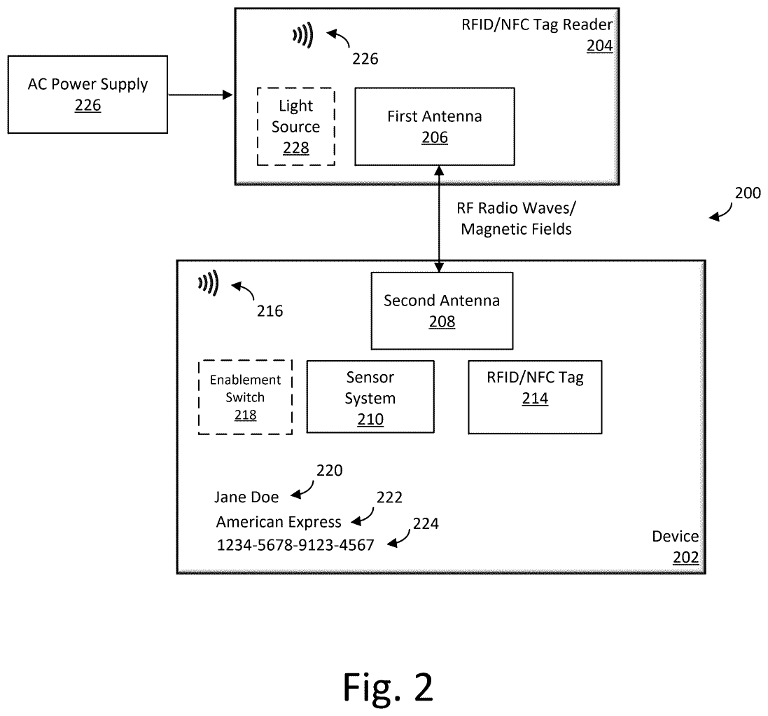

FIG. 2 depicts an example system 200 for secure RFID/NFC communication. System 200 includes a device 202 (which in the example of FIG. 2 is a credit card, but could also be a bus pass, key fob, or another type of device) that includes an RFID/NFC tag 214. The RFID/NFC tag 214 may be an NFC tag or another type of RFID tag, and may be powered (e.g., connected to a power source) or passive (e.g., lacking a physical connection to a power source such as a battery or electrical outlet). The system 200 includes an RFID/NFC tag reader 204 that is powered by an AC power supply 226. In some examples, such as for credit card tag/reader systems, the device 202 and/or RFID/NFC tag reader 204 includes a visual indication 216, 227 that the device 202 and/or RFID/NFC tag reader 204 are capable of contactless NFC-based transactions. In some examples, a surface of the device 202 is imprinted with various information about the device 202, such as an account number 224 associated with the device, a brand 222 associated with the device 202, and/or a registered user 220 of the device.

The RFID/NFC tag reader 204 includes a first antenna 206 that outputs an electromagnetic field in response to receiving an electric current. For example, the first antenna 206 may be, or may include, an RF antenna that generates radio waves or for NFC-based systems, and the first antenna 206 may be, or may include, an inductor (e.g., a conductive coil such as an air core coil, iron core coil, or ferrite core coil) that produces magnetic fields. The RFID/NFC tag reader 204 is configured to supply an electric current to the first antenna 206 to cause the first antenna to transmit information, such as by inducing a magnetic field in an inductor of the first antenna 206 and/or generating radio waves. The magnetic fields or radio waves radiate away from the first antenna 206 (e.g., they are emitted, propagated, and/or transmitted by the first antenna 206). The current may be supplied to the first antenna 206 as an alternating current at a particular RF frequency, and may cause the radio waves or magnetic fields to be generated at the same frequency. For NFC-based systems, the frequency is a relatively low RF frequency such as 13.56 MHz. For non-NFC RFID-based systems, the RF signal (e.g., radio waves) may be transmitted at a different frequency within the RF frequency range. For example, automotive key fobs may use RF frequencies in the 300-900 MHz range.

The radio waves or magnetic fields emitted by the first antenna 206 are received at the second antenna 208, which may have characteristics similar to those of the first antenna 206. For example, the second antenna 208 may be an RF antenna or an NFC antenna (e.g., an inductor). If the second antenna 208 is or includes an inductor, a current is induced in the second antenna 208 when the second antenna 208 is exposed to a magnetic field (e.g., a magnetic field generated by the first antenna 206). In this manner, the first antenna 206 can send a request for information to the second antenna 208—and therefore, to the device 202. In addition, for passive NFC tags, the current induced in the second antenna 208 can be used to power up the RFID/NFC tag 214.

In some examples, the RFID/NFC tag 214 includes processing circuitry for retrieving and/or generating information, such as authentication information that may be used by the RFID/NFC tag reader 204 to authenticate transactions or operations associated with the device 202. Some or all of this information may be stored in a memory of the RFID/NFC tag 214, such as in flash memory and/or other types of non-volatile computer memory storage media. The information may include, for example, an identifier of the RFID/NFC tag 214, an identifier of a registered user of the RFID/NFC tag 214, an account number, or other types of information. In some examples, in response to receiving a request for information from the RFID/NFC tag reader 204 in the form of a computational challenge, the RFID/NFC tag computes a response to include in the information transmitted back to the RFID/NFC tag reader 204.

In some examples, the information retrieved and/or generated by the RFID/NFC tag 214 may be transmitted to the RFID/NFC tag reader 204 in response to the RFID/NFC tag 214 being powered up by a current induced in the second antenna 208 and/or in response to a sensor output of a sensor system 210 of the device 202 satisfying one or more criteria, as described in more detail below. In some examples, an induced current from the second antenna 208 is also used to power up some or all of the sensor system 210 (if the sensor system 210 requires power) and/or to power up optional separate control circuitry (e.g., processing circuitry that is physically separate from the processing circuitry in the RFID/NFC tag 214. Such separate circuitry is not shown in FIG. 2).

The sensor system 210 is included in or on the device 202 and includes one or more sensors configured to sense (e.g., detect) one or more physical inputs from the physical environment, such as by detecting light, pressure, touch, or other physical inputs. The sensor system 210 outputs a digital or analog signal that includes a representation of the detected physical input(s). Broadly, the sensor system 210 is used, by the device 202, to control whether the RFID/NFC tag 214 transmits information to the RFID/NFC tag reader 204 in response to receiving a request for information from the RFID/NFC tag reader 204. Such a determination may be based on whether the sensor system 210 detects conditions that suggest that the device 202 is being legitimately used (e.g., is not currently experiencing a relay attack). If the representation(s) of the physical input(s) detected by the sensor system 210 satisfy one or more criteria (e.g., the sensor system 210 detects conditions that indicate a threshold likelihood of legitimate usage, such as a 60%, 70%, 80%, 90%, or 95% likelihood of legitimate usage), the device 202 transmits the information. In contrast, if the sensor output fails to satisfy at least one of the one or more criteria (e.g., indicating that the device may be experiencing a relay attack), the device 202 does not transmit the information. For example, the device 202 may determine, based on the representation(s) of the detected physical input(s), that there is less than the threshold likelihood of legitimate usage, and in accordance with this determination, the device 202 may refrain from transmitting a response.

In some examples, the sensor system 210 is or includes a photodetector that detects light. In some examples, the presence of light may indicate that the device 202 is not in the user's purse or wallet and is unlikely to be experiencing a relay attack. In some examples, the sensor detects light of any wavelength, and in other examples the sensor system 210 is configured to detect or identify light having a wavelength within a specific wavelength range, such as infrared light. For example, an RFID/NFC tag reader 204 may emit infrared light (or light within another wavelength range) that is detected by the sensor system 210 on the device 202 when the device 202 is sufficiently close to the tag reader to be used for a transaction (e.g., within 10 cm of the RFID/NFC tag reader 204), thereby increasing the resilience of the device 202 to relay attacks (because the device 202 is unlikely to be exposed to infrared light under other circumstances).

Such an approach might be useful in situations where the device containing the RFID/NFC tag (e.g., device 202) is intended for a specific use and the entity relying on the RFID/NFC tag for security also controls the manufacture/operation of the RFID/NFC tag reader and can therefore control whether the reader includes an infrared (or other wavelength) light source. In the example of FIG. 2, the RFID/NFC tag reader 204 is depicted as having an (optional) light source 228, which may emit infrared light and/or other wavelengths of light.

In some examples, the device 202 (e.g., processing circuitry of the device 202) determines whether a representation of the light detected by the sensor system 210 (which may be light at a particular wavelength, or light in general) exceeds a light threshold and/or includes light within a particular wavelength range (e.g., satisfies light criteria). The light threshold may be expressed in terms of a binary present/not present value, or in light-related units such as amperes per watt (A/W), optical flux, lumens, or lumens/cm². If the representation of the light satisfies the light criteria, the device 202 transmits a response to the RFID/NFC tag reader 204.

In some examples, the sensor system 210 is or includes a pressure sensor that detects a pressure at a location on a surface of the device 202 (such as the pressure that may be caused by a person's finger(s) pressing on the transaction card while holding the device 202). In some examples, the device 202 (e.g., processing circuitry of the device 202) determines whether a representation of the pressure detected by the sensor system 210 exceeds a pressure threshold and/or exceeds a pressure threshold in a particular area (e.g., satisfies pressure criteria). The pressure threshold may be expressed in terms of a binary present/not present value, or in pressure-related units such as pascals. atmospheres (atm), pounds per square inch (psi) or other units. If the representation of the pressure satisfies the pressure criteria, the device 202 transmits a response to the RFID/NFC tag reader 204.

In some examples, the sensor system is or include a touch sensor (e.g., a capacitive sensor, a resistive touch sensor, or another type of sensor that is configured to detect a person's touch on the device 202). In some examples, the device 202 (e.g., processing circuitry of the device 202) determines whether a representation of the touch detected by the sensor system 210 exceeds a touch threshold and/or a touch is detected at a particular location on the device (e.g., satisfies a touch criteria). The touch threshold may be expressed in terms of a binary present/not present value, or in units of capacitance or resistance (or a change in these values), or in other units. If the representation of the touch satisfies the touch criteria, the device 202 transmits a response to the RFID/NFC tag reader 204.

In some examples, the sensor system 210 is or includes a passive sensor that functions as a coupling switch to connect or disconnect current that is induced in the second antenna 208 to/from the RFID/NFC tag 214. For example, the sensor system 210 may include a photoresistor that couples the RFID/NFC tag 214 with the second antenna 208 when it detects an amount of light, such as an amount of light that satisfies a light threshold (which suggests legitimate usage of the device). When the photoresistor detects an amount of light that satisfies the light threshold, the photoresistor closes the circuit between the second antenna 208 and the RFID/NFC tag 214 (and optionally, between the second antenna 208 and the control circuitry discussed earlier). Closing the circuit in this manner provides the induced electric current (power) to the RFID/NFC tag 214, which may cause the RFID/NFC tag 214 to be powered up and/or to transmit the requested information via the second antenna 208. For active RFID/NFC tags, closing the circuit in this manner may allow data communicated by the RFID/NFC tag reader to be provided to the RFID/NFC tag, which may cause the RFID/NFC tag 214 to respond by transmitting the requested information.

In other examples, the sensor output (e.g., the representation(s) of the detected physical input(s)) is provided to processing circuitry within the RFID/NFC tag 214 or within separate control circuitry), and the processing circuitry determines whether to transmit the information based on the sensor output.

Optionally, the device 202 includes an enablement switch 218 that may be used to control whether the device 202 will use the sensor system 210 (and/or whether the sensor system 210 itself is electrically enabled) to control the behavior of the RFID/NFC tag 214. The enablement switch 218 may be implemented as a physical switch on the device 202 and/or as a configuration setting that is stored in a memory of the device 202, for example. The enablement switch 218 may have two, three, or more possible settings, such as “enabled” or “disabled” (e.g., indicating whether the user has enabled the use of the sensor system 210 to control whether the device 202 responds to a request from an RFID/NFC tag reader 204). For example, if the enablement switch 218 has a setting of “enabled,” the device 202 may use the sensor outputs to determine whether to transmit a response. If the enablement switch 218 has a setting of “disabled,” the device 202 may transmit a response without using the sensor outputs (if any). In the latter case, the device 202 may function as though it does not have a sensor system 210.

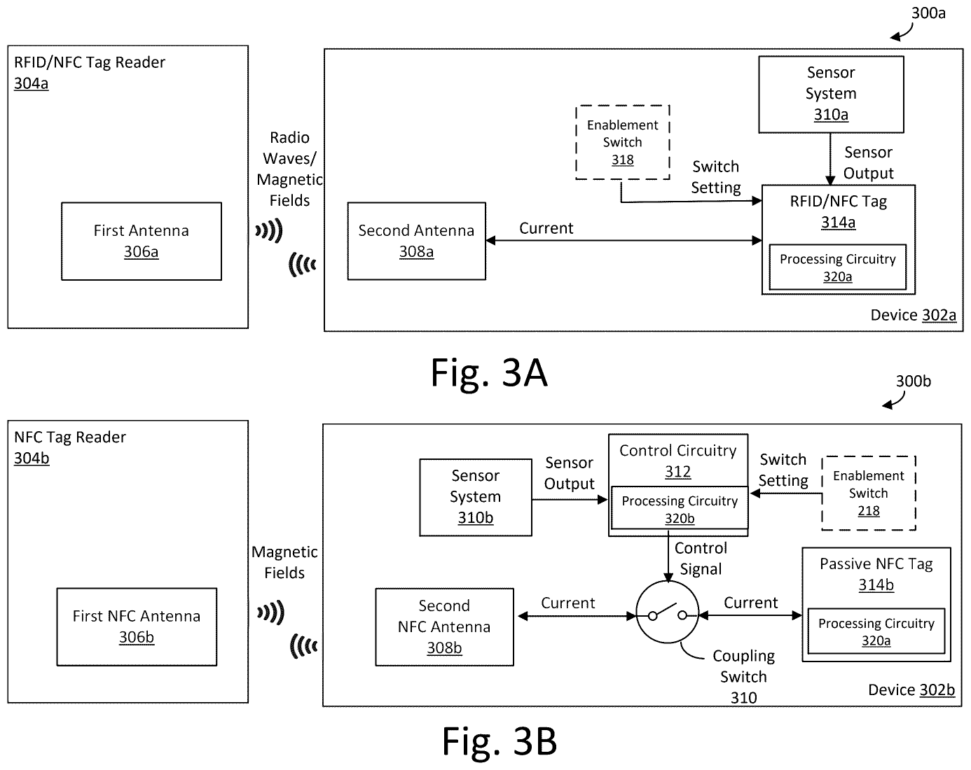

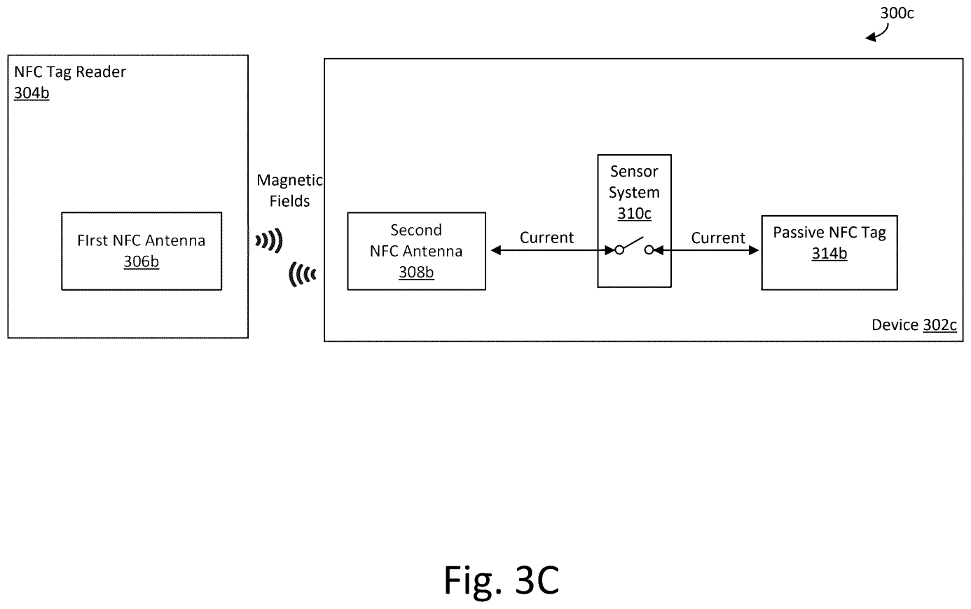

Various implementations of the systems and methods described herein are depicted in FIGS. 3A-3C. A person of skill in the art will appreciate that other implementations are possible without departing from the scope of the invention.

FIG. 3A depicts an RFID/NFC-based system 300a configured to perform RFID- or NFC-based transactions. The system 300a includes a device 302a (e.g., which may be an example of device 202 described with reference to FIG. 2) and an RFID/NFC tag reader 304a (which may be an example of RFID/NFC tag reader 204). The RFID/NFC tag reader 304a includes a first antenna 306a and the RFID/NFC tag reader 304a includes a second NFC antenna 308b. The device 302a also includes a sensor system 310a that includes one or more sensors that are configured to detect one or more physical inputs (e.g., inputs from a physical environment of the device 302). The sensor system 310a is configured to output, to the RFID/NFC tag 314a, one or more signals representing the detected physical input(s).

Optionally, the device 302a includes an enablement switch 318 that provides a switch setting to the RFID/NFC tag 314a (e.g., such that the RFID/NFC tag 314a enables or disables the use of outputs from the sensor system 210). In other implementations the enablement switch 318 may be used to enable or disable the sensor system 310a itself. Each of these elements may share the characteristics described with respect to similarly named elements in FIG. 2.

As previously discussed, many types of sensors may be used in the sensor system 310a. For example, the sensor system 310a may include a photodetector that detects the presence of an amount of light around the device 302a, which may indicate whether the device 302 is being held by a user and is not in the user's wallet, purse, or pocket. In some examples, the photodetector may be configured to detect the presence of a specific type of light, such as infrared light. The presence of light (and/or an amount of light above a light threshold) may represent a relatively high likelihood of legitimate usage, whereas an absence of light (and/or an amount of light below a light threshold) may represent a relatively low likelihood of legitimate usage.

As noted above, the device 302a may include an enablement switch 318 (shown as an optional element in FIG. 3A). The enablement switch 318 may be or may correspond to a physical switch (e.g., mechanical switch or another type of switch) that is located on or within the device 302a, and/or to a configuration setting stored on the device 302a. The setting of the enablement switch 318 may indicate whether the user has enabled the use of the sensor system 310a on the device 302a for detecting conditions that suggest legitimate usage of the device 302a, such as the presence of light, touch, and/or pressure. For example, if the enablement switch 318 is included in the device and is set to “enabled,” the device determines, based on the detection by the sensor(s) of one or more inputs from the physical environment, whether to transmit information to an RFID/NFC tag reader in response to receiving a request from the tag reader. If the enablement switch 318 is set to a “disabled” setting, the device 302a transmits information to the RFID/NFC tag reader 304a in response to receiving a request for information from the tag reader regardless of input(s) detected from the physical environment (e.g., by sensor(s) in the sensor system).

In some examples, radio waves and/or magnetic fields received at the second antenna 308a are converted into electric current/voltage and supplied to the RFID/NFC tag 314a (which may be passive or separately powered). The RFID/NFC tag 314a is coupled with the sensor system 310a and configured to receive a sensor output from the sensor system 310a. In some examples, the electric current supplies power to the RFID/NFC tag 314a to cause the RFID/NFC tag 314a to power up (if the RFID/NFC tag 314a is a passive NFC tag), and/or includes data transmitted by the RFID/NFC tag reader 304 to the RFID/NFC tag 314a. In the example of FIG. 3A, processing circuitry 320a in the RFID/NFC tag 314 (e.g., a microcontroller or other processing circuitry) determines, based on the sensor output from the sensor system 310a (and/or based on the switch setting received from the enablement switch 318, if present), whether to respond to the request for information by transmitting information to the RFID/NFC tag reader 304. If the sensor output (e.g., the representation(s) of the physical inputs(s) detected by sensor(s) of the sensor system 310a) satisfies each of the one or more criteria (e.g., a set of one or more predetermined criteria, such as a light criterion, pressure criterion, touch criterion, or other criterion), the device 302a transmits the information. If the sensor output fails to satisfy the criteria (e.g., by failing to satisfy at least one of the one or more of the criteria), the device 302a refrains from transmitting the information.

In some examples, if the sensor output fails to satisfy the criteria, the device 302a issues an alert to notify a user that the device may be the target of a relay attack. For example, in response to determining that the sensor output fails to satisfy the criteria, the device 302a may enable (e.g., set) an indicator internally (such as by storing the indicator in a register of the RFID/NFC tag 314) or externally (such as by displaying the indicator or issuing another type of alert) that indicates that the sensor output failed to satisfy the criteria, and/or may transmit the indicator to the RFID/NFC tag reader during a subsequent communication. In some examples, the device 302a tracks a number of instances in which the sensor output fails to satisfy the criteria (e.g., by incrementing a value in a register of the RFID/NFC tag), and transmits the number of instances to the RFID/NFC tag reader during a subsequent communication.

FIG. 3B depicts an example of an NFC-based system 300b. System 300b is similar to system 300a and includes some elements that are similar to or the same as those depicted in FIG. 3A. FIG. 3B, however, depicts an example in which the RFID/NFC tag is a passive NFC tag 314b that is powered up (e.g., turned on) by electric current induced in a second NFC antenna 308b (e.g., an inductor), such as current induced by a magnetic field emitted from a first NFC antenna 306b of an NFC tag reader 304b.

The device 302b includes additional circuitry relative to device 302a. In particular, device 302b includes control circuitry 312 that is coupled with a sensor system 310b and with a coupling switch 310. The control circuitry 312 includes processing circuitry (such as a microcontroller) and is configured to determine, based on the sensor output from the sensor system 310a (and/or based on the switch setting of the enablement switch 318, if present) whether to enable the passive NFC tag 314b to be powered up and transmit information in response to receiving a current from the second NFC antenna 316a. That is, rather than using processing circuitry in the NFC tag 314b to perform this function, separate control circuitry 312 (having processing circuitry 320b) is used to determine whether to allow the electric current to reach the passive NFC tag 314b. The control circuitry 312 may be passive (e.g., receiving power via the second NFC antenna 308b, like a passive NFC tag) or active (e.g., receiving power via a different power source, such as a battery). In some examples, if the control circuitry 312 determines that the sensor output (and therefore the representation(s) of the detected physical input(s)) satisfies each of one or more criteria, the control circuitry 312 outputs a first control signal to cause the coupling switch 310 to close (or remain closed) thereby coupling the second NFC antenna 308b with the passive NFC tag 314b and allowing current to flow to the passive NFC tag 314b. This in turn may cause the passive NFC tag 314b to be powered up and transmit the information by sending a second electric current to the second NFC antenna 308b. The second electric current may induce a second magnetic field in the second NFC antenna 308b, which then induces a current in the first NFC antenna 306b at the NFC tag reader 304b to provide the information to the tag reader as described with reference to FIG. 2.

In contrast, if the control circuitry 312 determines that the sensor output fails to satisfy at least one of the one or more criteria, the control circuitry 312 may output a second control signal (or refrain from outputting a control signal) to cause the coupling switch to open (or to remain open) such that the passive NFC tag 314b does not receive the electric current, does not power up, and does not transmit the information.

As shown in the example NFC-based system 300c of FIG. 3C, in some cases, a sensor system 310c is or includes a passive sensor that itself serves as a coupling switch under certain conditions. In this relatively simple and inexpensive approach, the sensor system 310c may be or may include a photoresistor that closes the circuit between the second NFC antenna 308b and the passive NFC tag 314b when the sensor system 310c detects light around the device 302c, such as daylight or infrared light (e.g., light that satisfies light criteria, as previously discussed). In this case, the sensor output is a reduction in resistance of the photoresistor in response to exposure to light (or to an amount light that satisfies a light threshold). Thus, the sensor system 310c allows electric current induced in the first NFC antenna 316b to be provided to the second NFC antenna 308b when the device 302c is exposed to light.

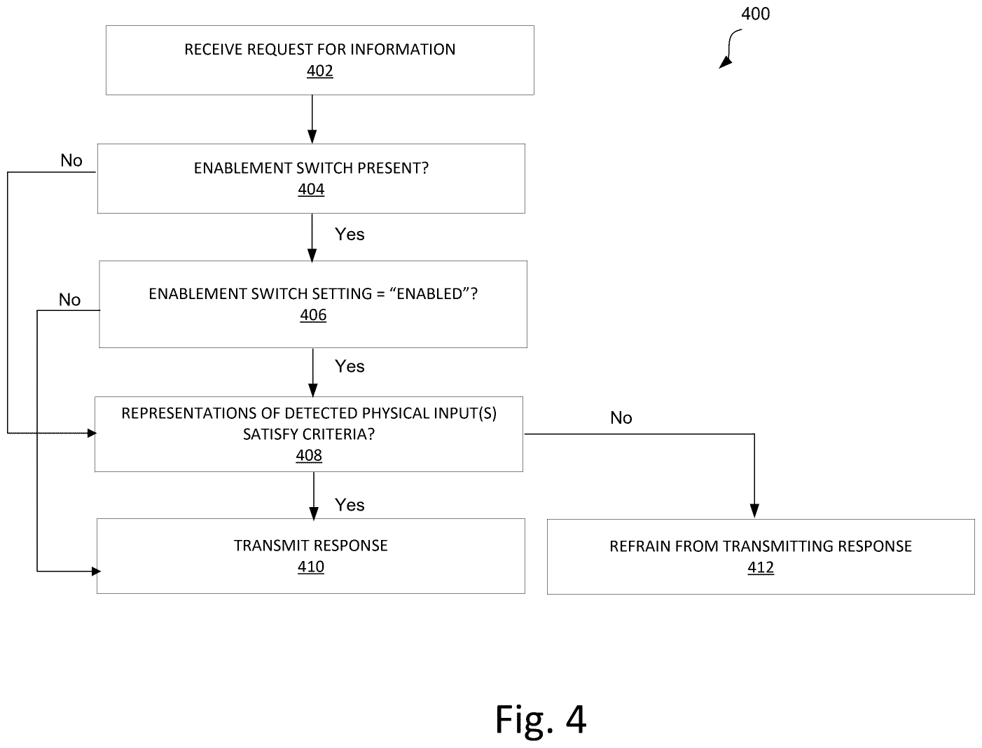

FIG. 4 depicts an example flowchart 400 for providing secure RFID/NFC-based communications according to aspects of the present application. Flowchart 400 may be performed by an RFID/NFC tag-equipped device, such as device 202, 302. Certain elements of flowchart 400 can be rearranged and/or omitted, depending on the device implementation.

In some examples, at 402, a request for information is received at a device from a tag reader. In response to receiving the request, and if at 404 an enablement switch is present on the device (e.g., enablement switch 318), then at 406, the device determines whether the enablement switch is set to an “enabled” setting indicating that a sensor system of the device should be used to determine whether the device is likely to be experiencing a relay attack (e.g., using methods described herein).

If the enablement switch is set to “enabled,” the device determines, at 408, whether representation(s) of physical input(s) detected by one or more sensors of the sensor system each satisfy a corresponding criterion (or multiple criteria). For example, the device determines whether an amount of light (which may be any wavelength of light or light within a particular wavelength range, such as infrared light) detected by a photodetector satisfies a light threshold, and/or whether an amount of pressure detected by a pressure detector satisfies a pressure threshold, and/or whether a touch contact is detected (or satisfies a touch threshold). If each of the criteria are satisfied, the device transmits (outputs) a response to the request for information (e.g., via the antenna). In some examples, the device actively determines whether the representations of the physical inputs satisfy corresponding criteria, using processing circuitry on the device. In other examples, the sensor system includes a passive sensor (such as a photoresistor) that passively “determines” whether the detected physical input (light) satisfies the light criteria by increasing or decreasing its resistance in response to the presence or absence of light (or of an amount of light that satisfies a light threshold).

If the representation(s) of the physical input(s) satisfy the criteria, or if an enablement switch is present and is set to “disabled,” then at 410 the device transmits a response.

If any of the physical inputs detected by one or more sensors in the sensor system fails to satisfy corresponding criteria, or if the enablement switch is present and set to “enabled” and any of the physical inputs detected by one or more sensors in the sensor system fails to satisfy a corresponding criteria, then at 412 the device refrains from transmitting a response.

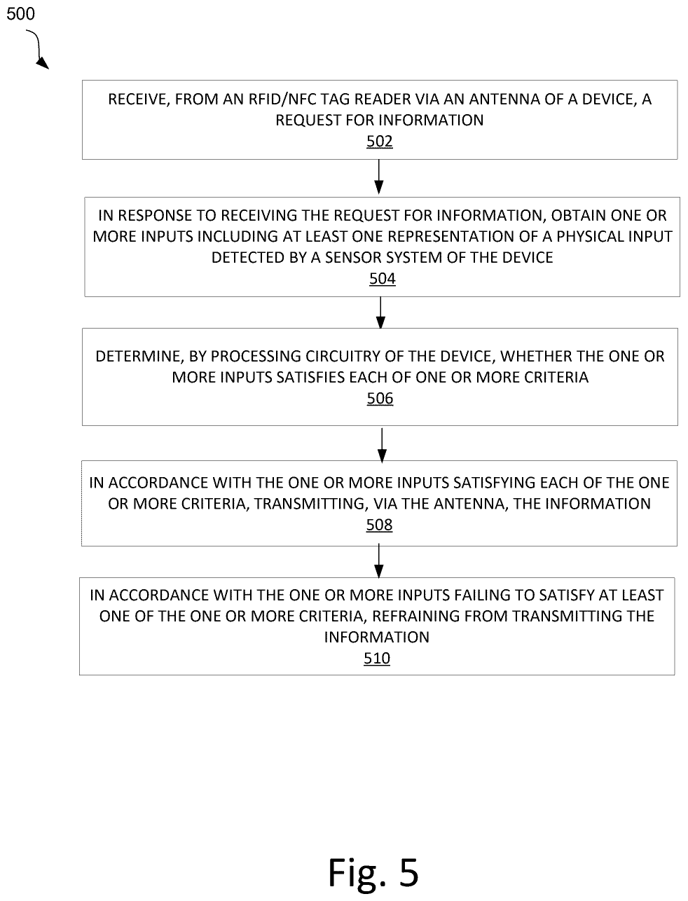

FIG. 5 depicts an example method 500 according to aspects of the present application. In examples, one or more of the operations of FIG. 5 can be performed by various elements (such as processing circuitry, sensor systems, control circuitry, switches, or the like) that are included in an RFID- and/or NFC-equipped device (e.g., a device that includes an RFID tag and/or NFC tag), such in devices 202, 302a, 302b, and/or 302c, or in other types of devices that include similar elements. In other examples, some or all of the operations described below as being performed by a device having an RFID/NFC tag may be performed by an RFID/NFC tag reader, and some or all of the operations described as being performed by the RFID/NFC tag reader may be performed by the device having an RFID/NFC tag.

At operation 502, the device receives, from an RFID/NFC tag reader (e.g., RFID/NFC tag reader 204, 304a, NFC tag reader 304b) via an antenna of the device (e.g., second antenna 208, 308a and/or second NFC antenna 308b), a request for information. In some examples, the request for information is received as a magnetic field(s) and/or radio waves that causes the antenna to output a first electric current (e.g., via induction or another mechanism). In some examples, the request for information has a frequency in the RF range (e.g., 30 Hz-300 GHz) and in some cases, within the NFC frequency range (e.g., approximately 13.56 MHz or another frequency).

At operation 504, in response to receiving the request for information, the device obtains one or more inputs including at least one representation of a physical input detected by a sensor system of the device. For example, the device obtains one or more representations of physical inputs via a sensor system of the device, which detects the physical input(s) and outputs representation(s) of the detected physical inputs. For example, the device obtains a setting of an enablement switch (if present).

At operation 506, optionally, processing circuitry of the device determines whether the one or more inputs satisfies each of the one or more criteria. For example, the processing circuitry determines whether the enablement switch is set to “disabled” and/or whether each of the representation(s) of the physical input(s) satisfy corresponding criteria as previously discussed.

At operation 508, in accordance with the one or more inputs satisfying each of the one or more criteria, the device transmits, via the antenna, the information. In some examples, the device transmits the information by generating a second electric current (e.g., an AC current in the RF and possibly NFC frequency range) and providing the second electric current to the antenna. In some examples, the second electric current has the same RF frequency as the received signal (e.g., the current induced in the antenna) such that the tag reader and the device communicate using the same frequencies. In some examples, the second electric current causes a corresponding magnetic field to be induced in the antenna (e.g., if the antenna is an NFC antenna).

At operation 510, in accordance with the one or more inputs failing to satisfy at least one of the one or more criteria, the device refrains from transmitting the information. For example, the one or more inputs may fail to satisfy criteria when the sensor system detects that the device is not exposed to light that satisfies light criteria, and/or that the device has not detected pressure that satisfies pressure criteria, and/or that the device is not being touched. As an illustrative example, if the sensor output indicates that the device is exposed to light and the enablement switch is set to “enabled” (meaning that the sensor system is to be used for security purposes), the device does not transmit the information (e.g., the device does not generate and/or supply an electric current to the antenna for transmission). Many other possible combinations of criteria may be used to determine whether the device transmits the information.

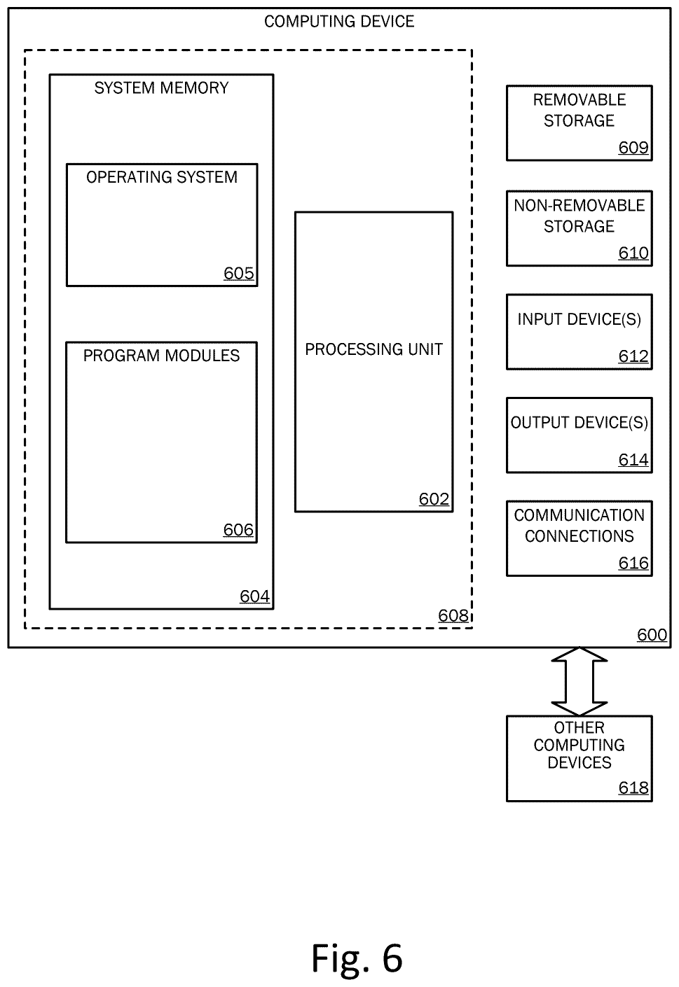

FIG. 6 is a block diagram illustrating physical components (i.e., hardware) of a computing device 600 (e.g., a microcontroller including processing circuitry) with which examples of the present disclosure may be practiced. The computing device components described below may be suitable for a computing device(s) implementing (or included in) a RFID/NFC tag 102, an RFID/NFC tag reader 104, and/or control circuitry 312. The computing device 600 may include at least one processing unit 602 and a system memory 604. The processing unit(s) (e.g., processors) may be referred to as a processing system or processing circuitry. Depending on the configuration and type of computing device, the system memory 604 may comprise, but is not necessarily limited to, volatile storage (e.g., random access memory), non-volatile storage (e.g., read-only memory), flash memory, or any combination of such memories. In some examples, the system memory 604 includes an operating system 605 and one or more program modules 606 suitable for running software applications 660 to implement one or more of the components or systems described above with respect to FIGS. 1-5. In some examples, the computing device is hardwired and does not include an operating system 605 and/or program modules 606. The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, one or more of the operations of the methods illustrated in FIGS. 4-5. For example, if computing device 600 is included in a RFID/NFC tag reader, program modules 606 may include one or more modules for generating electric currents to request information from an RFID/NFC tag. For example, if computing device 600 is included in a RFID/NFC tag, program modules 606 may include one or more modules for determining whether to transmit information to a tag reader in response to receiving a request for information and/or for generating electric currents representing requested information. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618 and/or systems (such as devices and/or systems depicted in FIG. 2-3C). Examples of suitable communication connections 616 include, but are not limited to, an RF transmitter, receiver, and/or transceiver circuitry; RF antenna, NFC antenna (inductor), universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600 and/or coupled with computing device 600. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, RF, electromagnetic, infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed:

1. A method performed at a device having a radio frequency identification (RFID)/near-field communication (NFC) tag, the method comprising:
receiving, from an RFID/NFC tag reader via an antenna of the device, a request for information;
in response to receiving the request for information, obtaining one or more inputs including at least one representation of a physical input detected by a sensor system of the device;
in accordance with the one or more inputs satisfying each of one or more criteria, transmitting, via the antenna, the information; and
in accordance with the one or more inputs failing to satisfy at least one of the one or more criteria, refraining from transmitting the information.

2. The method of claim 1, wherein the RFID/NFC tag is a near-field communication (NFC) tag and the antenna comprises an inductor, and wherein receiving the request for information via the antenna comprises generating, by the inductor of the antenna, a first electric current in response to exposure to a magnetic field.

3. The method of claim 2, wherein the first electric current has an RF frequency associated with NFC communications.

4. The method of claim 2, wherein the RFID/NFC tag is a passive NFC tag and wherein, in accordance with one or more inputs satisfying the one or more criteria, the first electric current is supplied to the passive NFC tag to cause the NFC tag to be powered up.

5. The method of claim 4, wherein the information is transmitted in response to the NFC tag being powered up.

6. The method of claim 4, wherein the sensor system comprises a photoresistor coupled between the antenna and the passive NFC tag and configured to establish an electrical connection between the antenna and the NFC tag when the sensor system detects light that satisfies light criteria.

7. The method of claim 1, further comprising determining, by processing circuitry of the device, whether the one or more inputs satisfies the one or more criteria.

8. The method of claim 1, wherein the sensor system comprises a photodetector configured to detect light impinging on the device, the representation of the physical input includes a representation of the detected light, and the one or more inputs satisfies a first criterion of the one or more criteria when the representation of the detected light satisfies light criteria.

9. The method of claim 1, wherein the sensor system comprises a pressure sensor system configured to detect a pressure on a surface of the device, the representation of the physical input includes a representation of the detected pressure, and the one or more inputs satisfies a second criterion of the one or more criteria when the representation of the detected pressure satisfies pressure criteria.

10. The method of claim 1, wherein the sensor system comprises a touch sensor system configured to detect a physical touch on the device, the representation of the physical input includes a representation of the detected physical touch, and the one or more inputs satisfies a third criterion of the one or more criteria when the representation of the detected physical touch satisfies touch criteria.

11. The method of claim 1, wherein the one or more inputs comprises an enablement switch setting, and the one or more criteria fail to be satisfied when the enablement switch setting is set to an enabled setting and the representation of the physical input fails to satisfy a first criterion of the one or more criteria.

12. The method of claim 1, wherein the one or more inputs comprises an enablement switch setting, and each of the one or more criteria are satisfied when the enablement switch setting is a disabled setting.

13. A device comprising:
a passive near-field communication (NFC) tag that includes processing circuitry;
an antenna comprising an inductor configured to generate an electric current in response to exposure to a magnetic field; and
a sensor system configured to detect a physical input;
wherein the device is configured to:
generate, using the inductor, a first electric current based on exposure to a magnetic field generated by an NFC tag reader, wherein the first electric current includes a request for information from the NFC tag reader,
in response to generating the first electric current, obtaining one or more inputs including at least one representation of a physical input detected by a sensor system of the device;
in accordance with the one or more inputs satisfying each of the one or more criteria, providing a second electric current to the antenna to transmit the information; and
in accordance with the one or more inputs failing to satisfy at least one of the one or more criteria, refraining from providing the second electric current to the antenna.

14. The device of claim 13, wherein the second electric current represents the information in a format that conforms to an NFC communication protocol.

15. The device of claim 13, wherein the first electric current is supplied to the passive NFC tag to cause the passive NFC tag to be powered up.

16. The device of claim 13, wherein the sensor system comprises a photoresistor coupled between the inductor and the passive NFC tag and configured to establish an electrical connection between the inductor and the passive NFC tag when the sensor system detects light that satisfies light criteria.

17. The device of claim 13, wherein the second electric current is provided to the antenna in response to the passive NFC tag being powered up.

18. The device of claim 13, wherein the information includes data stored on the device.

19. The device of claim 13, wherein the passive NFC tag is coupled with the inductor and the sensor system and configured to receive the first electric current from the inductor and the sensor output from the sensor, and wherein the processing circuitry of the passive NFC tag is configured to determine whether the one or more inputs satisfies the one or more criteria.

20. A device comprising:
a radio-frequency identification (RFID) tag that includes processing circuitry;
an RF antenna configured to generate an electrical current in response to receiving a signal in an RF frequency range; and
a sensor system configured to detect one or more physical inputs;
wherein the device is configured to:
in response to receiving the signal, detect, using a photoresistor of the device, an amount of light impinging on the device;
in accordance with the amount of light exceeding a light threshold, obtain information from storage on the device and provide a second electric current representing the information to the antenna for transmission; and
in accordance with the amount of light failing to exceed the light threshold, refrain from providing the second electric current to the antenna.
